(19) United States
(12) Patent Application Publication
(10) Pub. No.: US 2026/0276534 A1
(43) Pub. Date: Sep. 17, 2026

(54) COMPONENT MOUNTING METHOD, GAS DETECTION APPARATUS BOARD, AND GAS DETECTION APPARATUS SYSTEM

(71) Applicant: Asahi Kasei Microdevices Corporation, Tokyo (JP)

(72) Inventor: Yuta TAKAGI, Tokyo (JP)

(73) Assignee: Asahi Kasei Microdevices Corporation, Tokyo (JP)

(21) Appl. No.: 19/468,196

(22) Filed: Feb. 3, 2026

(30) Foreign Application Priority Data
Feb. 7, 2025 (JP) 2025-019610
Jan. 30, 2026 (JP) 2026-014784

(51) Int. Cl. G01N 21/3504

(52) U.S. Cl. CPC G01N 21/3504; G01N 2201/127

(57) ABSTRACT

A new component mounting method suitable for the production of gas detection apparatuses and the like is proposed. A component mounting method according to one embodiment includes a first step of mounting a light emitter, a light detector, and a controller on a first surface of a first board including external electrodes, a second step of fixing an optical member to the first surface, a third step of calibrating an output of at least one of the light emitter, the light detector, and the controller, in accordance with first detection information output from the light detector, and a fourth step of mounting a second surface of the first board on one surface of a second board.

### TECHNICAL FIELD

The present disclosure relates to a component mounting method, a gas detection apparatus board, and a gas detection apparatus system.

### BACKGROUND

In a known technique, a plurality of mounted components mounted on a board by reflow are covered with two resin layers made of a thermoplastic resin and a thermosetting resin, and deformation of the board, such as warpage, is suppressed when a module sealed with these resin layers is mounted on a motherboard by a second reflow (see, for example, Patent Literature (PTL) 1).

### Citation List

### Patent Literature

PTL 1: WO 2012/096277 A1

### SUMMARY

However, when the conventional component mounting method is applied to the production of gas detection apparatuses and the like, there is room for improvement in terms of measures to address factors that affect the measurement accuracy or reliability of the final product. It would be helpful to provide a new component mounting method suitable for the production of gas detection apparatuses and the like.

A component mounting method according to one embodiment includes a first step of mounting a light emitter, a light detector, and a controller on a first surface of a first board comprising external electrodes having at least a first external electrode terminal group and a second external electrode terminal group, a second step of fixing, to the first surface, an optical member configured to propagate light from the light emitter to the light detector, the optical member covering the light emitter, the light detector, and the controller and having a shape capable of forming a predetermined space between the optical member and the first surface of the first board, a third step of calibrating an output of at least one of the light emitter, the light detector, and the controller, in accordance with first detection information based on an output of the light detector, and a fourth step of mounting a second surface of the first board on one surface of a second board, wherein in the fourth step, the first external electrode terminal group is connected to the second board, the second external electrode terminal group is removed from the first board, and when observed from a direction perpendicular to the first surface of the first board, centers of gravity of areas respectively occupied by the light emitter and the light detector are at positions different from a center of gravity of an area occupied by the external electrodes.

A gas detection apparatus board according to one embodiment includes a first board including external electrodes having at least a first external electrode terminal group and a second external electrode terminal group; a light detector, a light emitter, and a controller mounted on a first surface of the first board, and an optical member fixed to the first surface of the first board so as to cover the light detector, the light emitter, the controller, and a windproof filter, wherein the second external electrode terminal group has a guide for removal from the first board, and a number of electrodes in the second external electrode terminal group is equal to or greater than a number of electrodes in the first external electrode terminal group.

A gas detection apparatus system according to an embodiment includes a first board; a light emitter, a light detector, a controller, and a storage mounted on a first surface of the first board, the storage storing at least calibration information; an optical member covering the light emitter, the light detector, and the controller, having a shape capable of forming a predetermined space between the optical member and the first surface of the first board, and having a ventilation opening at a position not overlapping with the light emitter and the light detector in a direction perpendicular to the first board; a plurality of external electrodes arranged on a second surface of the first board, when observed from a direction perpendicular to the first surface of the first board, centers of gravity of areas respectively occupied by the light emitter and the light detector being at positions different from a center of gravity of an area occupied by the plurality of external electrodes, and a second board connected to the plurality of external electrodes of the first board, wherein power is supplied from the second board to the first board through the plurality of external electrodes, and after power is supplied, self-calibration can be performed in accordance with detection information and the calibration information, the detection information being based on an output of the light detector.

According to the present disclosure, a new component mounting method suitable for the production of gas detection apparatuses and the like can be provided.

### BRIEF DESCRIPTION OF THE DRAWINGS

In the accompanying drawings:

FIG. 1 is a schematic diagram illustrating an example configuration of a component mounting system according to an embodiment of the present disclosure;

FIG. 2A is a schematic cross-sectional view illustrating an example configuration of a gas detection apparatus according to an embodiment of the present disclosure;

FIG. 2B is a schematic top view illustrating an example configuration of a gas detection apparatus according to an embodiment of the present disclosure;

FIG. 3 is a schematic top view illustrating an example configuration of the gas detection apparatus according to an embodiment of the present disclosure;

FIG. 4A is a schematic cross-sectional view illustrating an example configuration of a gas detection apparatus according to an embodiment of the present disclosure;

FIG. 4B is a schematic cross-sectional view illustrating an example configuration of a gas detection apparatus according to an embodiment of the present disclosure;

FIG. 5 is a flowchart illustrating an example of a component mounting method according to an embodiment of the present disclosure;

FIG. 6A is a schematic top view and a schematic cross-sectional view illustrating an example of a component mounting method according to an embodiment of the present disclosure;

FIG. 6B is a schematic cross-sectional view illustrating an example of a component mounting method according to an embodiment of the present disclosure;

FIG. 6C is a schematic top view and a schematic cross-sectional view illustrating an example of a component mounting method according to an embodiment of the present disclosure;

FIG. 6D is a schematic cross-sectional view illustrating an example of a component mounting method according to an embodiment of the present disclosure;

FIG. 6E is a schematic cross-sectional view illustrating an example configuration of a component mounting system according to an embodiment of the present disclosure;

FIG. 7A is a schematic top view of an example of a board provided in a component mounting system according to an embodiment of the present disclosure; and

FIG. 7B is a schematic bottom view of an example of a board provided in a component mounting system according to an embodiment of the present disclosure.

### DETAILED DESCRIPTION

Hereinafter, an embodiment of the present disclosure will be described in detail with reference to the drawings. As a general rule, the same components are given the same reference numerals, and redundant explanations are omitted. In each drawing, the aspect ratio of each component is exaggerated from the actual ratio for the sake of convenience.

Furthermore, in the present specification, for the sake of convenience, "top" refers to the optical member side depicted in the drawings, and "bottom" refers to the board side depicted in the drawings. However, the terms "top" and "bottom" are merely defined for convenience and should not be interpreted in a restrictive manner.

In addition, in the present specification, "reflow" refers to the well-known reflow soldering process, that is, a process in which cream solder is printed on a board, components are placed on the solder, and then the solder is melted in a high-temperature furnace to perform soldering.

### Component Mounting System

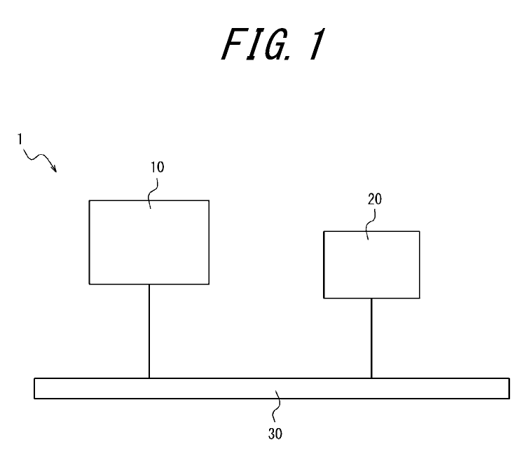

An example of the configuration of a component mounting system 1 according to the present embodiment will be described with reference to FIG. 1.

As illustrated in FIG. 1, the component mounting system 1 includes a gas detection apparatus 10, a control apparatus 20, and a motherboard 30 (second board). The gas detection apparatus 10 and the control apparatus 20 are mounted on the motherboard 30. The gas detection apparatus 10 and the control apparatus 20 are communicably connected to each other and transmit and receive information.

### Gas detection apparatus

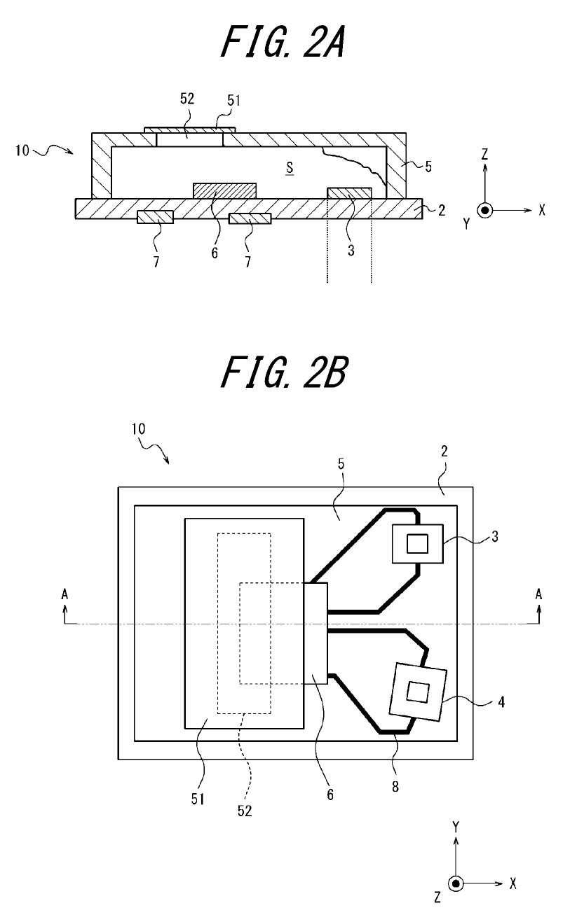

An example of the configuration of the gas detection apparatus 10 according to the present embodiment will be described with reference to FIGS. 2A, 2B, 3, 4A, and 4B. FIG. 2A is a schematic cross-sectional view illustrating an example configuration of the gas detection apparatus 10 taken along line A-A illustrated in FIG. 2B. In FIGS. 2A, 2B, 3, 4A, and 4B, Cartesian coordinates are set so that the X direction or the Y direction is horizontal relative to a board 2, and the Z direction is perpendicular to the board 2. The gas detection apparatus 10 is a small apparatus having a length in the X direction of 10 mm to 20 mm, a length in the Y direction of 15 mm to 35 mm, and a length in the Z direction of 4 mm to 12 mm, for example.

The gas detection apparatus 10 includes the board 2 (first board), a light emitter 3, a light detector 4, an optical member 5, a controller 6, a plurality of external electrodes 7, and wiring 8. The gas detection apparatus 10 is, for example, a Non Dispersive InfraRed (NDIR) type apparatus that detects the concentration of an introduced gas to be detected based on the amount of infrared light absorbed by the gas to be detected. The gas to be detected is, for example, carbon dioxide, methane, water vapor, propane, formaldehyde, carbon monoxide, hydrogen sulfide, nitrogen monoxide, nitrous oxide, ammonia, sulfur dioxide, alcohol (methanol, ethanol, or the like), a refrigerant gas (R32, R1234yf, R290, or the like), MCH (methylcyclohexane), or a mixed gas thereof.

The gas detection apparatus 10 turns on when power to the motherboard 30 is turned on and turns off when power to motherboard 30 is turned off. The gas detection apparatus 10 is communicably connected to the control apparatus 20 and transmits and receives information to and from the control apparatus 20. The gas detection apparatus 10 may be switched in response to a signal from a CPU or microcomputer on the motherboard 30.

The configuration of the gas detection apparatus according to the present embodiment can be applied to detecting leaks of refrigerant gas in air conditioners and the like. In recent years, gases with a low global warming potential (GWP) have been used as refrigerant gases for air conditioners in view of their impact on global warming. Examples include R32 and R290. These low GWP refrigerant gases are generally flammable. To prevent explosions caused by gas leaks, gas detection apparatuses are used to detect refrigerant gas leaks.

The configuration of the gas detection apparatus in the present embodiment enables application as a light emitting and receiving device for purposes other than gas detection. In other words, the disclosed matter derived by replacing the above-described "gas detection apparatus" with "optical concentration measurement apparatus", "optical physical quantity measurement apparatus", "light receiving and emitting apparatus", "optical apparatus", and the like is included in the scope of the present disclosure. For example, the state of the optical path space (as an example other than gas, the presence or concentration of a specific component of a fluid) can be detected. For example, the present disclosure can be used in a component detection apparatus, component concentration measurement device, or the like for a substance (such as water or a bodily fluid) present in the optical path space between the light emitter and the light detector. For example, when the substance present in the optical path space is blood, the component detection apparatus or component concentration measurement apparatus can be used to measure the glucose concentration in the blood.

The component detection apparatus or component concentration measurement device can measure the glucose concentration in blood sugar by measuring the absorption of light with a wavelength of 1 μm to 10 μm. In measuring the glucose concentration in blood sugar, the absorption of light at 1.6 μm, 2.0 μm to 2.3 μm, and 9.6 μm is preferably measured. A small, highly accurate, and highly reliable non-invasive glucose meter can be achieved. Such glucose meters allow, for example, diabetic patients to accurately measure their own blood glucose levels without causing damage to the skin, which occurs with invasive methods. Furthermore, more accurate medication (e.g., insulin) management can be achieved based on the measured blood glucose level.

### Board

The light emitter 3, the light detector 4, the controller 6, and the like are mounted on the board 2 by a first reflow (first time reflow is performed). The board 2 also includes a plurality of external electrodes 7 on the bottom surface (second surface), which is the surface opposite to the surface (first surface) on which the light emitter 3, the light detector 4, the controller 6, and the like are mounted. Some of the external electrodes 7 may also be located on the first surface.

The board 2 is, for example, a printed circuit board, a flexible printed circuit board, a rigid-flexible board, or a ceramic board. The board 2 includes metal wiring, a base material, resin, and the like. Examples of the base material include paper, glass cloth, polyimide film, PET film, and ceramic. Examples of the resin include phenol resin, epoxy resin, polyimide resin, bismaleimide triazine resin, fluororesin, and polyphenylene oxide resin.

### Light emitter

The light emitter 3 emits light, in a wavelength band that includes a wavelength that is absorbed by the gas to be detected, in response to a drive current or drive voltage supplied from the controller 6. The light emitter 3 emits light in a wavelength band of, for example, 2.0 μm or more and 12.0 μm or less. The configuration of the light emitter 3 is not particularly limited, as long as the light emitter 3 emits light in a wavelength band that includes a wavelength absorbed by the gas to be detected. The light emitter 3 may further include an optical filter that has the function of selectively transmitting light in a certain wavelength band.

The light emitter 3 is, for example, a light emitting diode (LED), a lamp, light amplification by stimulated emission of radiation (laser), an organic light emitter, a micro-electromechanical systems (MEMS) heater, a vertical-cavity surface-emitting laser (VCSEL), or a photonic-crystal surface-emitting laser (PCSEL). The light emitter 3 may further include an auxiliary optical unit having a light collecting function or a wavelength selecting function. The auxiliary optical unit is, for example, a lens, a wavelength selection filter, a diffraction grating, or the like.

The light emitter 3 is arranged on the board 2 so as not to overlap with the plurality of external electrodes 7 in the direction perpendicular to the board 2, is then mounted on the board 2 by the first reflow, and is electrically connected to the controller 6 and the like via the wiring 8 (see FIGS. 2A and 2B). Being arranged on the board 2 so that the light emitter 3 does not overlap with the plurality of external electrodes 7 in the direction perpendicular to the board 2 means that when an operator observes the gas detection apparatus 10 from the direction perpendicular to the first surface of the board 2, the center of gravity of the area occupied by the light emitter 3 can be observed to be at a different position from the center of gravity of the area occupied by the plurality of external electrodes 7.

By mounting the light emitter 3 on the board 2 so as not to overlap with the plurality of external electrodes 7 in the direction perpendicular to the board 2, i.e., by the plurality of external electrodes 7 not being located directly below the light emitter 3 (see dotted line in FIG. 2A), the heat transferred from the plurality of external electrodes 7 to the light emitter 3 when mounting the gas detection apparatus 10 on the motherboard 30 by a second reflow (second time reflow is performed) can be reduced. This can prevent problems such as thermal deterioration of the light emitter 3 and misalignment of the light emitter 3 due to remelting of the solder that joined the light emitter 3 on the board 2, thereby suppressing a decrease in the reliability of the gas detection apparatus 10 mounted on the motherboard 30 by the second reflow. Furthermore, by mounting the light emitter 3 on the board 2 so as not to overlap with the plurality of external electrodes 7 in the direction perpendicular to the board 2, X-ray inspection of the light detector 4 can be facilitated.

### Light detector

The light detector 4 has sensitivity to a wavelength band including wavelengths absorbed by the gas to be detected and receives light that has passed through the gas to be detected. The light detector 4 receives light in a wavelength band of, for example, 2.0 μm or more and 12.0 μm or less. The light detector 4 outputs detection information to the controller 6 in accordance with the amount of received light. The detection information includes information indicating the concentration of the gas to be detected, information indicating the output current of the light detector 4 when the light emitter 3 is driven by the controller 6, and the like. The higher the concentration of the gas to be detected, the smaller the amount of light received by the light detector 4, whereas the lower the concentration of the gas to be detected, the larger the amount of light received by the light detector 4.

The light detector 4 is, for example, a photodiode, a phototransistor, a thermopile, a pyroelectric sensor, a bolometer, or a photoacoustic detector. The light detector 4 may include an auxiliary optical unit having a light collecting function or a wavelength selecting function. The auxiliary optical unit is, for example, a lens, a wavelength selection filter, a diffraction grating, or the like.

The light detector 4 is arranged on the board 2 so as not to overlap with the plurality of external electrodes 7 in the direction perpendicular to the board 2, is then mounted on the board 2 by the first reflow, and is electrically connected to the controller 6 and the like via the wiring 8. Being arranged on the board 2 so that the light detector 4 does not overlap with the plurality of external electrodes 7 in the direction perpendicular to the board 2 means that when an operator observes the gas detection apparatus 10 from the direction perpendicular to the first surface of the board 2, the center of gravity of the area occupied by the light detector 4 can be observed to be at a different position from the center of gravity of the area occupied by the plurality of external electrodes 7.

By mounting the light detector 4 on the board 2 so that it does not overlap with the plurality of external electrodes 7 in the direction perpendicular to the board 2, i.e., by the plurality of external electrodes 7 not being located directly below the light detector 4, the heat transferred from the plurality of external electrodes 7 to the light detector 4 when mounting the gas detection apparatus 10 on the motherboard 30 by a second reflow can be reduced. This can prevent problems such as thermal deterioration of the light detector 4 and misalignment of the light detector 4 due to remelting of the solder that joined the light detector 4 on the board 2, thereby suppressing a decrease in the reliability of the gas detection apparatus 10 mounted on the motherboard 30 by the second reflow. Furthermore, by mounting the light detector 4 on the board 2 so as not to overlap with the plurality of external electrodes 7 in the direction perpendicular to the board 2, X-ray inspection of the light detector 4 can be facilitated.

For example, when the optical member 5 is an imaging optical system, the area of the light receiving surface of the light detector 4 is preferably equal to or greater than the area of the image formed on the light receiving surface. Specifically, the area of the light receiving surface is preferably 1.5 times or more the area of the image and more preferably 2 times or more the area of the image. By having the area of the light receiving surface satisfy this range, the image formed on the light receiving surface can be contained within the light receiving surface even if the position of the image formed on the light receiving surface changes slightly due to, for example, variation in the environment such as temperature and humidity or deformation of the optical member 5 due to deterioration over time. This makes it possible to suppress changes in the amount of light propagating from the light emitter 3 to the light detector 4, thereby reducing deterioration in the gas detection performance of the gas detection apparatus 10.

### Optical member

The optical member 5 reflects the light emitted by the light emitter 3 one or more times in a detection space S and guides the light to the light detector 4. The optical member 5 optically connects the light emitter 3 and the light detector 4. The optical member 5 may, for example, be an imaging optical system that combines a plurality of quadric mirrors. The optical member 5 may be formed from one member or from a plurality of members.

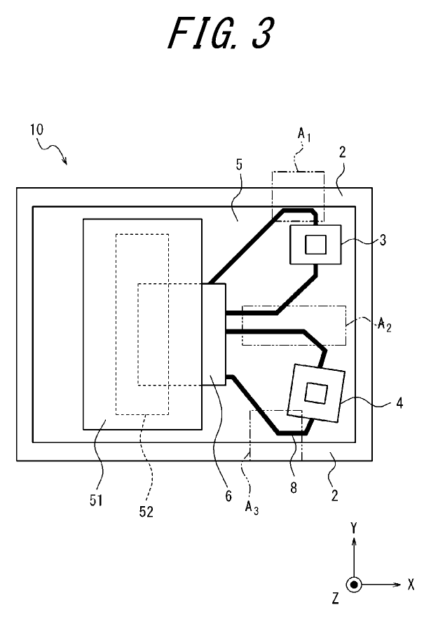

As illustrated in FIG. 3, the optical member 5 is fixed to the board 2 in areas A1, A2, and A3 so as to contact the wiring 8 by adhesive, crimping, fitting, pins, screws, claws, grommets, welding, or clips, for example. Since the optical member 5 is in contact with the wiring 8 in the areas A1, A2, and A3, the heat generated when the gas detection apparatus 10 is mounted on the motherboard 30 by the second reflow can be dissipated to the outside via the wiring 8. This can prevent problems such as thermal deterioration of the light emitter 3 and the light detector 4, misalignment of the light emitter 3 and the light detector 4 due to remelting of the solder, and corrosion of the optical member 5 due to a flux vaporized during soldering or reflow, thereby suppressing a decrease in the reliability of the gas detection apparatus 10 mounted on the motherboard 30 by the second reflow.

Furthermore, the optical member 5 is preferably provided on the board 2 so as not to overlap with vias, through-holes, and the like of the board 2. In other words, preferably no vias, through-holes, and the like exist in the detection space S surrounded by the optical member 5 and the board 2, and if vias, through-holes, or the like do exist, they are preferably filled using a known filling process. This prevents vaporized flux from flowing into the gas detection apparatus 10 through vias, through-holes, and the like and hitting the optical member 5 when the gas detection apparatus 10 is mounted on the motherboard 30 by the second reflow.

The optical member 5 includes, for example, a resin housing and a reflector. Examples of materials for the resin housing include liquid crystal polymer (LCP), polypropylene (PP), polyether ether ketone (PEEK), polyamide (PA), polyphenylene ether (PPE), polycarbonate (PC), polyphenylene sulfide (PPS), polymethyl methacrylate resin (PMMA), and hard resins made from a mixture of two or more of these. Here, in order to withstand the high temperature (240 °C or higher) during reflow and ensure that the reflector functions properly, PPS is particularly useful. Examples of materials for the reflector include metal, glass, ceramic, and stainless steel. From the viewpoint of improving detection sensitivity, the reflector is preferably formed from a material with a small light absorption coefficient and high reflectance. Examples of such materials include alloys containing aluminum, gold, and silver; dielectrics; and laminates thereof. Furthermore, from the perspective of reliability and deterioration over time, the reflector may be formed of gold or an alloy layer containing gold. Here, the reflector may be further provided with a coating serving as a base, to prevent corrosion, or the like, depending on the material of the reflector. For example, for an aluminum reflector, a plasma polymerized film containing Si is generally used as the base and protective film. These coatings can improve the reliability of the reflector. Furthermore, the optical member 5 may contain beads, fillers, or the like within these materials.

The inner surface of the optical member 5 preferably has a dielectric laminate film formed on the surface of the metal layer. This can increase the reflectance. Furthermore, the inner surface of the optical member 5 is preferably formed on a resin housing by vapor deposition, sputtering, or plating. This improves the productivity of the gas detection apparatus 10 and also reduces its weight. Furthermore, since the difference in thermal expansion coefficient between the board 2 and the optical member 5 can be reduced, thermal deformation of the gas detection apparatus 10 can be suppressed, and fluctuations in detection sensitivity can be suppressed.

The average reflectance (total of specular reflection and diffuse reflection) of light in the range of 2 μm to 20 μm by the optical member 5 is preferably a high reflectance of 70 % or more across at least 50 % of the outer surface. As a method for realizing high reflectance, for example, a coating similar to the reflective coating on the inner surface may be applied to the outer surface, or an aluminum seal may be attached to the outer surface of the optical member 5. The reflective coating may be applied to the outer surface of the optical member 5 before the optical member 5 is fixed onto the board 2. Alternatively, the reflective coating may be applied to the outer surface of the optical member 5 after the optical member 5 has been fixed onto the board 2 and before the second reflow is performed. As a result of the outer surface of the optical member 5 being reflectively coated at least by the time the second reflow is performed, a large amount of light can be reflected to the outside, thereby suppressing a rise in temperature of the optical member 5 and promoting the heat-shielding effect inside the gas detection apparatus 10.

Furthermore, the optical member 5 preferably has a large heat capacity. This configuration can make it difficult for heat generated when the gas detection apparatus 10 is mounted on motherboard 30 by the second reflow to be transmitted to the light emitter 3 or the light detector 4.

The manufacturing process of the optical member 5 is not particularly limited, but the optical member 5 may, for example, be formed by cutting, pressing, or the like. Furthermore, the optical member 5 may be formed by injection molding in consideration of productivity or the like. When the optical member 5 includes a plurality of reflectors, the plurality of reflectors may be integrally formed. By integrally molding a plurality of reflectors, the assembly process can be simplified and productivity can be increased. The reflector is formed by molding a base, an aluminum thin film, and a protective film onto plastic using a plasma polymerization film formation apparatus.

The optical member 5 may include various optical elements such as an ellipsoidal mirror, a flat mirror, a concave mirror, a convex mirror, a lens, and a diffraction grating.

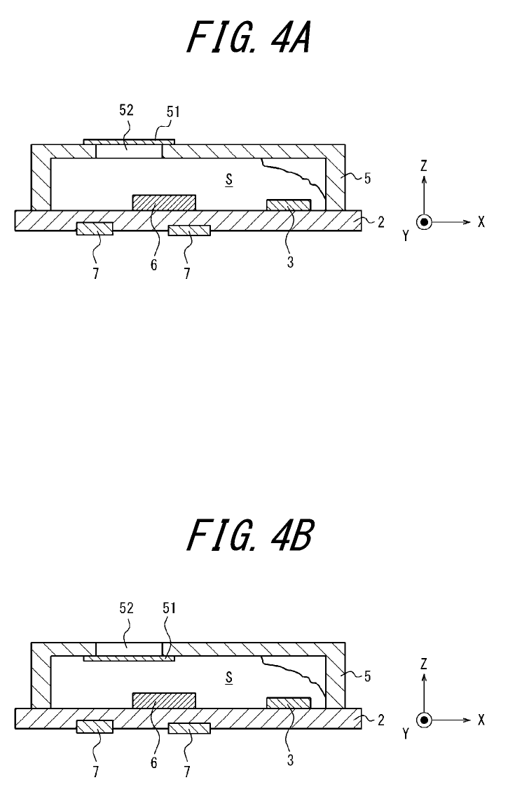

As illustrated in FIGS. 4A and 4B, the optical member 5 includes a windproof filter 51 and a ventilation opening 52. The windproof filter 51 is attached to the ventilation opening 52 to prevent hot air and the like from entering the detection space S. The windproof filter 51 may, for example, be a nonwoven fabric or a PTFE film. Any material that can withstand the heat during the reflow process may be used. As illustrated in FIG. 4A, the windproof filter 51 may be provided above the ventilation opening 52, that is, on the outer surface side of the optical member 5. When the windproof filter 51 is provided on the outer surface side of optical member 5, wind pressure acting on the gas detection apparatus 10 can be suppressed. Alternatively, the windproof filter 51 may be provided below the ventilation opening 52, that is, on the inner surface side of the optical member 5, as illustrated in FIG. 4B. When the windproof filter 51 is provided on the inner surface side of the optical member 5, the problem of deterioration, due to heat, of the adhesive that bonds the optical member 5 and the windproof filter 51 can be suppressed during the second reflow, thereby improving the selectivity of the windproof filter 51.

The ventilation opening 52 ventilates the detection space S. The ventilation opening 52 is preferably provided at the top of the optical member 5. This makes it easier to attach the windproof filter 51 to the ventilation opening 52, and the manufacturing process of the optical member 5 becomes easier. Furthermore, the ventilation opening 52 is preferably provided so as not to overlap the light emitter 3 and the light detector 4 in the direction perpendicular to the board 2. This arrangement can suppress the influence of remelting during reflow. In the subsequent assembly process, the ventilation opening is the most susceptible to heat inflow. Heat can cause deterioration of the light emitter and the light detector, and can also cause misalignment. To prevent these problems, the heat inflow areas are preferably separated as far as possible. Specifically, the light emitter, light detector, and ventilation opening preferably do not overlap each other. The ventilation opening 52 may be provided on the side of the optical member 5.

The optical member 5 may include a waterproof filter. By providing the optical member 5 with a waterproof filter, the gas detection apparatus 10 can be structured to withstand the cleaning process after being mounted on the motherboard 30 by the second reflow.

### Controller

The controller 6 may include at least one of a general-purpose processor that executes functions according to the loaded program and a dedicated processor specialized for a particular process. The general-purpose processor may be, for example, a microcontroller (micro controller unit, or MCU). The dedicated processor is, for example, an application specific integrated circuit (ASIC).

The controller 6 controls the light emitter 3 and the light detector 4. The controller 6 executes various calculations in accordance with the detection information that is based on the output of the light detector 4. The detection information may, for example, be a signal output from the light detector 4, the signal may be temperature-corrected or humidity-corrected, or the signal may be converted into a gas concentration. The controller 6 can also control only the light emitter 3 in the gas detection apparatus 10. Alternatively, the controller 6 can control only the light detector 4 in the gas detection apparatus 10. The controller 6 may be provided inside the gas detection apparatus 10 or may be provided outside the gas detection apparatus 10.

The controller 6 calibrates the output of the gas detection apparatus 10 in accordance with the first detection information that is based on the output of the light detector 4 after the first reflow. For example, this calibration may involve associating the first detection information with reference information such as gas concentration, temperature, and humidity, and providing a calibration curve for calculating the gas concentration in accordance with the first detection information. In this case, reference information may be provided from a reference gas detection apparatus, temperature sensor, and humidity sensor, and calibration may be performed in an environment adjusted in accordance with the reference information. In addition, the controller 6 compares second detection information that is based on the output of the light detector 4 after calibration with third detection information that is based on the output of the light detector 4 after the second reflow and determines whether the output of the gas detection apparatus 10 is valid. When determining that the output of the gas detection apparatus 10 is not valid, the controller 6 further determines whether the output of the gas detection apparatus 10 can be restored by self-calibration. On the other hand, when determining that the output of the gas detection apparatus 10 is valid, the controller 6 ends the process. JP 2023-067808 A may be referred to for details of the "self-calibration" in the present specification. For example, as described in paragraph 0031 of this application, self-calibration may refer to "the gas sensor 600(corresponding to the gas detection apparatus 10 in the present embodiment) calibrating itself based on the gas concentration value calculated by the gas sensor 600. For example, a constant gas concentration value for a predetermined period, a maximum or minimum gas concentration value for a predetermined period, or the like may be used for the gas sensor 600 to calibrate itself. For example, if the gas sensor 600 is a CO₂ (carbon dioxide) sensor, the output of the gas sensor 600 may be self-corrected by the automatic baseline correction or automatic background calibration (ABC) algorithm".

When the controller 6 determines that the output of the gas detection apparatus 10 is not valid and that the output of the gas detection apparatus 10 can be recovered by self-calibration, the controller 6 transmits information to the control apparatus 20 indicating that the output of the gas detection apparatus 10 is not valid and that the output of the gas detection apparatus 10 can be recovered by self-calibration. The controller 6 then executes self-calibration using a predetermined algorithm in accordance with the second detection information and the third detection information. For example, when the gas to be detected is carbon dioxide or a refrigerant gas, the controller 6 can use the ABC algorithm. Environmental density information can also be acquired, and calibration processing to match that density information can be performed. For example, taking into account the operating environment, processing can be performed to calibrate to 400 ppm if the gas to be detected is CO₂ or to 0 ppm if the gas to be detected is a refrigerant gas.

The timing at which the controller 6 performs self-calibration may be arbitrarily controlled by the control apparatus 20. For example, if the controller 6 receives an instruction from the control apparatus 20 to perform self-calibration when the component mounting system 1 is started for the first time, the controller 6 may perform self-calibration when the component mounting system 1 is started for the first time. For example, if the controller 6 receives an instruction from the control apparatus 20 to perform self-calibration every time the component mounting system 1 is started up, the controller 6 may perform self-calibration every time the component mounting system 1 is started up.

On the other hand, when the controller 6 determines that the output of the gas detection apparatus 10 is not valid and that the output of the gas detection apparatus 10 cannot be recovered by self-calibration, the controller 6 transmits information to the control apparatus 20 indicating that the output of the gas detection apparatus 10 is not valid and that the output of the gas detection apparatus 10 cannot be recovered by self-calibration. This information indicates an error such that the output of the gas detection apparatus 10 has become distorted due to the failure of a second reflow process.

If the self-calibration is successfully performed, the controller 6 may transmit information indicating that the self-calibration has been successfully performed to the control apparatus 20. Furthermore, if the self-calibration is not successfully performed, the controller 6 may transmit information indicating that the self-calibration has not been successfully performed to the control apparatus 20.

For example, the controller 6 may be capable of performing self-calibration in response to input, from the light detector 4, of detection information satisfying a predetermined first condition, and may output an error flag in response to input, from the light detector 4, of detection information not satisfying the predetermined first condition. The first condition may, for example, be a condition indicating whether detection information is obtained within a range of, for example, ±10 % of a reference measurement result in an environment suitable for performing an examination or test.

The controller 6 may include a storage. The storage may, for example, be a semiconductor memory, a magnetic memory, an optical memory, or the like. The storage stores any information used in the operation of the controller 6. For example, the storage stores the first detection information output from the light detector 4 after the first reflow. For example, the storage stores the second detection information output from the light detector 4 after calibration. For example, the storage stores the third detection information output from the light detector 4 after the second reflow. For example, the storage may store calibration information. Examples of calibration information include information indicating the output of the light detector 4 at a certain concentration (400 ppm for CO₂, 0 ppm for refrigerant gas), information indicating a calibration curve that converts the output of the light detector 4 or the temperature-corrected output of the light detector 4 into a concentration, and the like. In addition, the storage stores, for example, various programs, various types of information, and the like. The storage does not necessarily have to be provided inside the controller 6 and may be provided outside the controller 6.

### External electrodes

The plurality of external electrodes 7 is provided on the bottom surface of the board 2 so as not to overlap with the light emitter 3 in the direction perpendicular to the board 2 (see the dotted lines in FIG. 2A). The plurality of external electrodes 7 may be provided on the side surfaces of the board 2 so as not to overlap with the light emitter 3 in the direction perpendicular to the board 2. By preventing the light emitter 3 and the plurality of external electrodes 7 from overlapping at least in the direction perpendicular to the board 2, the heat transferred from the plurality of external electrodes 7 to the light emitter 3 can be reduced when the gas detection apparatus 10 is mounted on the motherboard 30 by the second reflow. This can prevent problems such as thermal deterioration of the light emitter 3 and misalignment of the light emitter 3 due to remelting of the solder, thereby suppressing a decrease in the reliability of the gas detection apparatus 10 mounted on the motherboard 30 by the second reflow.

The plurality of external electrodes 7 is provided on the bottom surface of the board 2 so as not to overlap with the light detector 4 in the direction perpendicular to the board 2. The plurality of external electrodes 7 may be provided on the side surfaces of the board 2 so as not to overlap with the light detector 4 in the direction perpendicular to the board 2. By preventing the light detector 4 and the plurality of external electrodes 7 from overlapping at least in the direction perpendicular to the board 2, the heat transferred from the plurality of external electrodes 7 to the light detector 4 can be reduced when the gas detection apparatus 10 is mounted on the motherboard 30 by the second reflow. This can prevent problems such as thermal deterioration of the light detector 4 and misalignment of the light detector 4 due to remelting of the solder, thereby suppressing a decrease in the reliability of the gas detection apparatus 10 mounted on the motherboard 30 by the second reflow.

Furthermore, the plurality of external electrodes 7 is preferably provided on the bottom surface of the board 2 so as not to overlap with the reflector of the optical member 5 in the direction perpendicular to the board 2.

In this way, in the gas detection apparatus 10, the arrangement of the light emitter 3, the light detector 4, and the optical member 5 relative to the plurality of external electrodes 7 is designed to prevent excessive heat from being transferred to the light emitter 3 or the light detector 4 when the second reflow is performed. A decrease in reliability of the gas detection apparatus 10 mounted on the motherboard 30 by the second reflow can thus be suppressed.

The area of each of the external electrodes 7 is preferably 0.04 mm² or more and 25 mm² or less. The larger the area of each external electrode, the easier it is to heat the entire motherboard 30, thus contributing to efficiency of the second reflow process. On the other hand, the smaller the area of each external electrode, the higher the thermal resistance, making it more difficult for heat to be transferred to the light emitter 3, the light detector 4, and the like, and making it more difficult for the soldered parts of the light emitter 3, the light detector 4, and the like to remelt during the second reflow. Therefore, the area of each of the external electrodes 7 is preferably adjusted appropriately to satisfy this range.

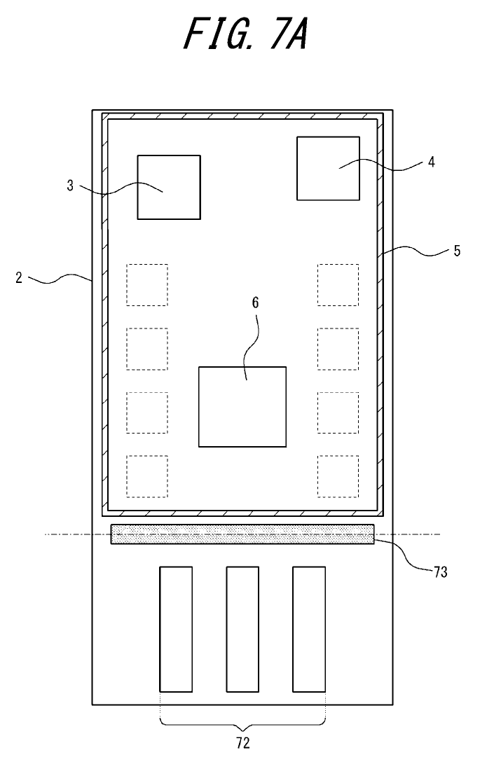

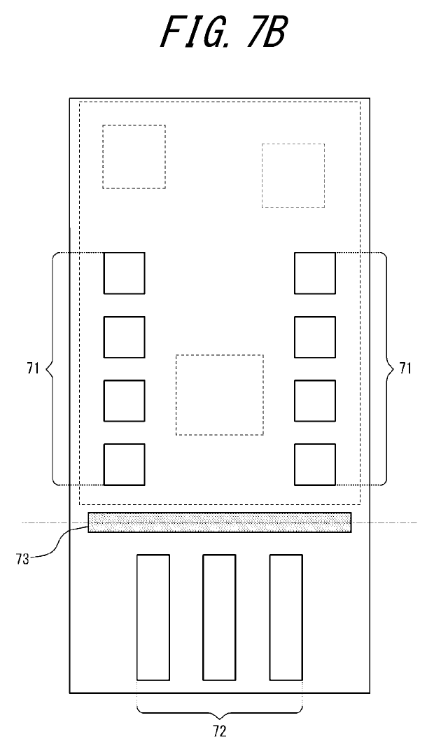

The plurality of external electrodes 7 may include, for example, a plurality of first external electrode terminals 71 (also referred to as a first external electrode terminal group) and a plurality of second external electrode terminals 72 (also referred to as a second external electrode terminal group), as illustrated in FIGS. 7A and 7B. FIG. 7A illustrates the state of the first surface of the board 2 at the stage of completion of step S103, and FIG. 7B illustrates the state of the second surface of the board 2 at the same stage. In each figure, a part indicated by a solid line indicates a part that can be observed from the outside on the surface, and a part indicated by a chain line indicates the position and region that corresponds to a part that can be observed from the outside on another surface. For ease of explanation, the optical member 5 is illustrated in a transparent state in FIG. 7A. The number of second external electrode terminals 72 is equal to or greater than the number of first external electrode terminals 71. For example, the plurality of first external electrode terminals 71 may be connected to the motherboard 30 and disposed on the bottom surface of the board 2. For example, the plurality of second external electrode terminals may be used for testing or calibration, and after the testing or calibration is completed, they may be removed from the board 2 along the dashed lines illustrated in FIGS. 7A and 7B. The plurality of second external electrode terminals may have a guide 73 for removal from the board 2, and examples of the guide 73 include a mouse bite, perforation, and a runner for board separation. Furthermore, the calibration program may be downloaded using the plurality of second external electrode terminals 72. By providing removable second external electrode terminals 72 for testing or calibration in this manner, the step of connecting the first external electrode terminals 71 during the testing or calibration work can be eliminated, and the likelihood of a deterioration in the quality of the connectivity between the first external electrode terminals 71 and the motherboard 30 can be reduced. The first external electrode terminals 71 may also be arranged so as to overlap the end of the board 2. This increases the number of mounting options during reflow. The first external electrode terminals 71 may be disposed inward from the end of the optical member 5 when viewed in a direction perpendicular to the first surface of the board 2. In other words, as illustrated in FIGS. 7A and 7B, when an overlapping region of the first surface that overlaps with the optical member 5 is identified as viewed in the direction perpendicular to the first surface of the board 2, the first external electrode terminals 71 (i.e., the external electrodes 7 after the second external electrode terminals 72 have been removed) are located within a region obtained by projecting the overlapping region onto the second surface of the board 2 along the perpendicular direction (i.e., the region surrounded by the corresponding position of the optical member 5 illustrated by the dashed line in FIG. 7B). With this configuration, when the gas detection apparatus 10 is mounted on the motherboard 30, the area occupied by the board 2 relative to the motherboard 30 can be minimized.

The plurality of first external electrode terminals 71 and the plurality of second external electrode terminals 72 may be connectable to different storages. For example, the plurality of first external electrode terminals 71 may be connected to a rewritable storage (first storage). For example, the plurality of second external electrode terminals 72 may be connected to a nonvolatile storage (second storage). The nonvolatile storage may be independent of the communication system of the plurality of first external electrode terminals 71. These storages may also be incorporated into the controller 6. This makes it possible to avoid unexpected or undesirable rewriting of built-in programs after the production process is completed. Furthermore, the controller 6 is permitted to access a first area of the storage in a case in which a signal is input from the plurality of second external electrode terminals 72 to the controller 6. On the other hand, the controller 6 is permitted limited access to a second area corresponding to a portion of the first area of the storage in a case in which a signal is input from the plurality of first external electrode terminals 71 to the controller 6. The address space of the memory that the controller 6 views and uses when access is from the plurality of first external electrode terminals 71 is narrower than the address space of the memory that the controller 6 views and uses when access is from the plurality of second external electrode terminals 72. Important programs and the like can therefore be placed in areas that are not accessed when access is from the plurality of first external electrode terminals 71, preventing alteration of the programs.

### Control apparatus

The control apparatus 20 is mounted on the motherboard 30 by the second reflow. The control apparatus 20 turns on when power to the motherboard 30 is turned on and turns off when power to motherboard 30 is turned off. The control apparatus 20 is communicably connected to the gas detection apparatus 10 and transmits and receives information to and from the gas detection apparatus 10.

The control apparatus 20 may include at least one of a general-purpose processor configured to execute functions based on a program and a dedicated processor specialized for a particular process. The general-purpose processor may be, for example, a microcontroller (micro controller unit, or MCU). The dedicated processor is, for example, an application specific integrated circuit (ASIC). The control apparatus 20 may include a storage. The storage does not necessarily have to be provided inside the control apparatus 20 and may be provided outside the control apparatus 20.

When the control apparatus 20 receives information from the gas detection apparatus 10 indicating that the output of the gas detection apparatus 10 is not valid and that the output of the gas detection apparatus 10 can be recovered by self-calibration, the control apparatus 20 generates an instruction to cause the gas detection apparatus 10 to perform self-calibration and transmits the instruction to the gas detection apparatus 10. The control apparatus 20 can arbitrarily control the timing for causing the gas detection apparatus 10 to execute self-calibration. For example, the control apparatus 20 may transmit an instruction to the gas detection apparatus 10 to cause the gas detection apparatus 10 to perform self-calibration when the component mounting system 1 is started up for the first time. For example, the control apparatus 20 may transmit an instruction to the gas detection apparatus 10 to cause the gas detection apparatus 10 to perform self-calibration every time the component mounting system 1 is started up.

When the control apparatus 20 receives information from the gas detection apparatus 10 indicating that the output of the gas detection apparatus 10 is not valid and that the output of the gas detection apparatus 10 cannot be recovered by self-calibration, the control apparatus 20 transmits, to the outside, a notification that an error has occurred in the gas detection apparatus 10. As a result, an error screen is displayed on a monitor or the like of an externally installed computer, for example.

The control apparatus 20 can also execute the same processes as those executed by the controller 6 described above. For example, the control apparatus 20 may receive, from the gas detection apparatus 10, first detection information output from the light detector 4 after the first reflow and calibrate the output of the gas detection apparatus 10 in accordance with the first detection information. Furthermore, for example, the control apparatus 20 may receive, from the gas detection apparatus 10, the second detection information output from the light detector 4 after calibration and the third detection information output from the light detector 4 after the second reflow and may compare the second detection information with the third detection information to determine whether the output of the gas detection apparatus 10 is valid.

### Motherboard

The gas detection apparatus 10, the control apparatus 20, and the like are mounted on the motherboard 30 by the second reflow process.

The motherboard 30 is, for example, a printed circuit board, a flexible printed circuit board, a rigid-flexible board, or a ceramic board. The motherboard 30 includes metal wiring, a base material, resin, and the like. Examples of the base material include paper, glass cloth, polyimide film, PET film, and ceramic. Examples of the resin include phenol resin, epoxy resin, polyimide resin, bismaleimide triazine resin, fluororesin, and polyphenylene oxide resin.

In the component mounting system 1 according to the present embodiment, the light emitter 3 and the light detector 4 are arranged on the board 2 so as not to overlap with the plurality of external electrodes 7 in a direction perpendicular to the board 2. The light emitter 3, the light detector 4, the controller 6, and the like are mounted on the board 2 by the first reflow. The gas detection apparatus 10, the control apparatus 20, and the like are mounted on the motherboard 30 by the second reflow. As a result, even though the gas detection apparatus 10 is mounted on the motherboard 30 by the second reflow, problems such as the solder remelting and causing the light emitter 3 and the light detector 4 to become misaligned on the board 2, or the flux vaporizing and adversely affecting the gas detection apparatus 10, do not occur. The reliability of the gas detection apparatus 10 mounted on the motherboard 30 by the second reflow can thereby be ensured.

### Component mounting method

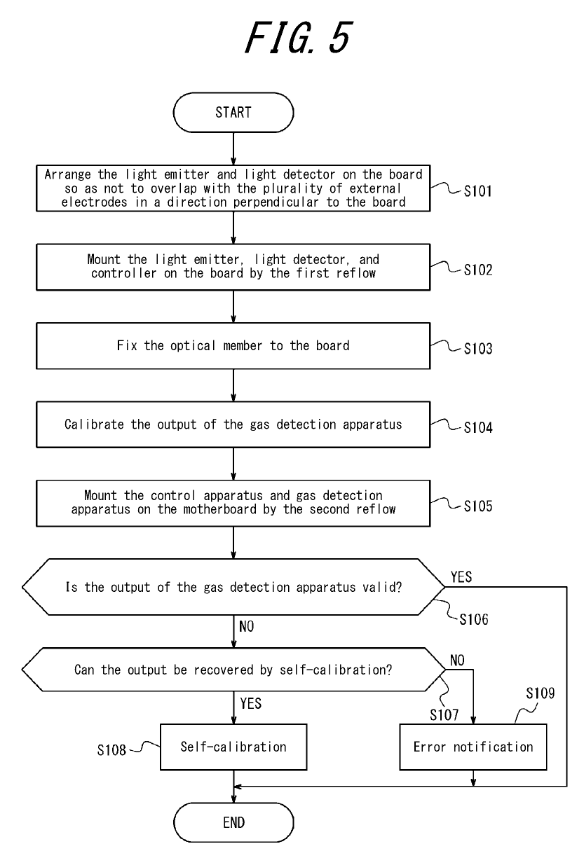

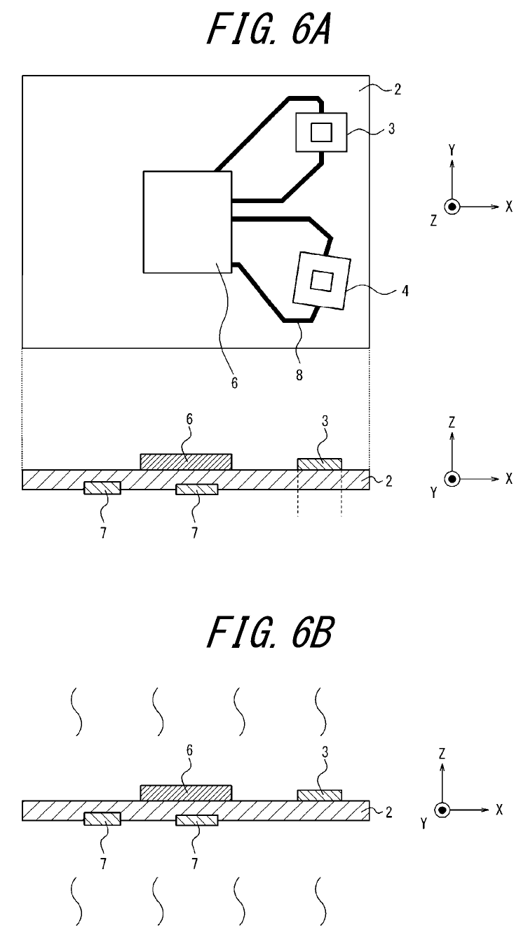

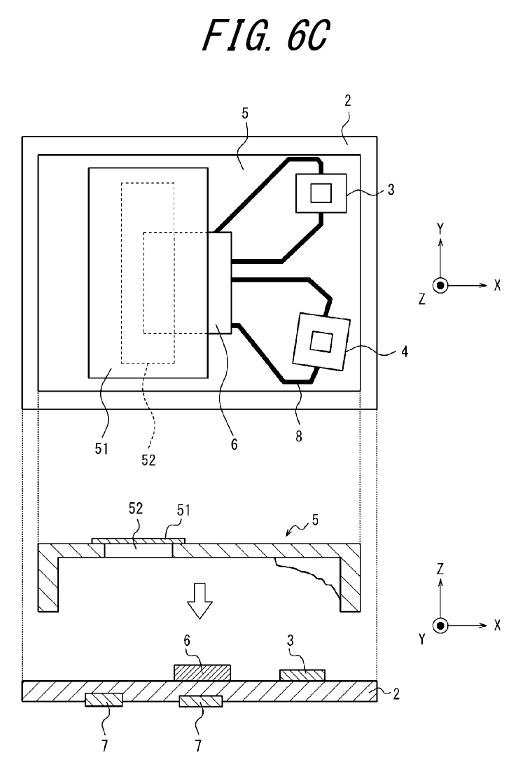

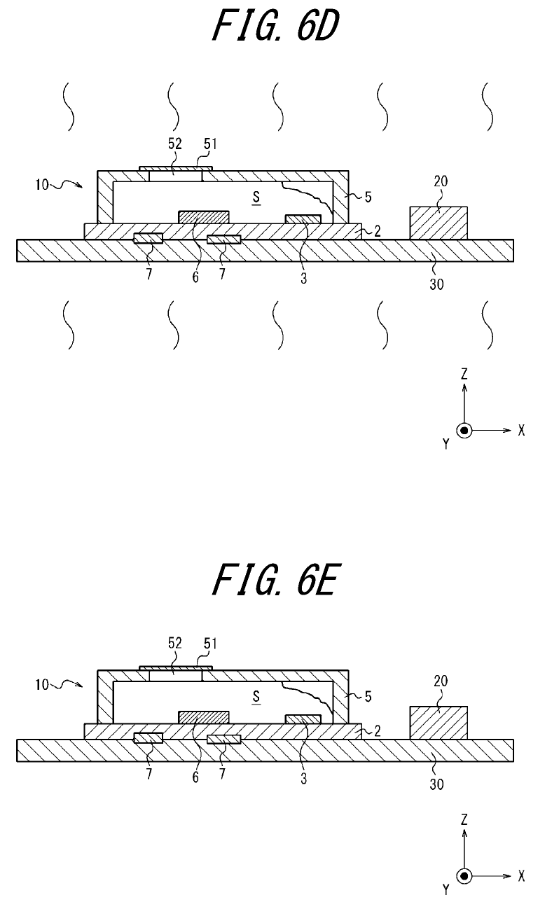

An example of a component mounting method according to the present embodiment will be described with reference to FIGS. 5 and 6A to 6F.

Each process will be described in detail below. The same components are given the same reference numerals, and the materials, functions, and the like of each component are as described above. Hence, duplicate explanations will be omitted. The external electrode terminals 72 are omitted from the figures.

In step S101, as illustrated in FIG. 6A, first, an operator prepares a board 2, which has a plurality of external electrodes 7 on the bottom surface, a light emitter 3, a light detector 4, and a controller 6. Next, the operator places the controller 6 on the board 2. Next, the operator places the light emitter 3 and the light detector 4 on the board 2 so as not to overlap with the plurality of external electrodes 7 in a direction perpendicular to the board 2.

In step S102, as illustrated in FIG. 6B, the operator mounts the light emitter 3, the light detector 4, and the controller 6 on the board 2 by a first reflow using a known reflow apparatus.

In step S103, as illustrated in FIG. 6C, the operator prepares an optical member 5 and a windproof filter 51 and attaches the windproof filter 51 to a ventilation opening 52. Next, the operator fixes the optical member 5, with the windproof filter 51 attached to the ventilation opening 52, onto the board 2, for example with an adhesive, so that the optical member 5 is set to overlap partially or entirely with the wiring 8 in a top view (see FIG. 3). The overlapped potion of the optical member 5 may be directly contacted to the wiring 8 or indirectly contacted to the wiring 8 via resist material. In this way, the gas detection apparatus 10 is completed.

In step S104, the controller 6 calibrates the output of the gas detection apparatus 10 in accordance with the first detection information output from light detector 4 after the first reflow. After the output of the gas detection apparatus 10 is calibrated and before the next step S105, second external electrode terminals 72 are removed from the board 2. The wiring connected to the second external electrode terminals 72 may remain on the board 2 even after the second external electrode terminals 72 are removed.

In step S105, as illustrated in FIG. 6D, the operator arranges the gas detection apparatus 10 on the motherboard 30 via a plurality of external electrodes 7. Next, the operator arranges the control apparatus 20 on the motherboard 30. Next, the operator mounts the gas detection apparatus 10 and the control apparatus 20 on the motherboard 30 by a second reflow process using a known reflow apparatus. As illustrated in FIG. 6E, the component mounting system 1 is thereby completed.

In step S106, the controller 6 compares second detection information output from the light detector 4 after calibration with third detection information output from the light detector 4 after the second reflow and determines whether the output of the gas detection apparatus 10 is valid. When determining that the output of the gas detection apparatus 10 is valid, the controller 6 ends the process (YES, proceed to END). When determining that the output of the gas detection apparatus 10 is not valid, the controller 6 executes the process of step S107 (NO, proceed to step S107).

In step S107, the controller 6 determines whether the output of the gas detection apparatus 10 can be recovered by self-calibration. When determining that the output of the gas detection apparatus 10 can be recovered by self-calibration, the controller 6 executes the process of step S108 (YES, proceed to step S108). When determining that the output of the gas detection apparatus 10 cannot be recovered by self-calibration, the controller 6 executes the process of step S109 (NO, proceed to step S109).

In step S108, the controller 6 executes self-calibration using a predetermined algorithm in accordance with the second detection information and the third detection information.

In step S109, the controller 6 transmits, to the control apparatus 20, information indicating an error such that the output of the gas detection apparatus 10 has become distorted due to the failure of the second reflow process.

The component mounting method described above reduces the likelihood that, when electronic components are mounted on a motherboard (second board) by a second reflow, the solder will remelt and cause a plurality of mounted components to become misaligned on the board, and the flux will vaporize and adversely affect the electronic components. This method thus suppresses a decrease in the reliability of electronic components mounted on a motherboard by a second reflow. For example, the component mounting system 1 mounted using the component mounting method of the present embodiment has a structure capable of withstanding second reflow and can suppress a decrease in the reliability of the gas detection apparatus 10 mounted on the motherboard 30 by second reflow. Specifically, thermal deterioration of the light emitter 3 and the light detector 4, misalignment of the light emitter 3 and the light detector 4 due to remelting of the solder, corrosion of the optical member 5 due to vaporization of the flux, and the like can be prevented. Furthermore, since the windproof filter 51 is attached to the ventilation opening 52 at least by the time the second reflow is performed, hot air can be prevented from entering the inside of the gas detection apparatus 10 during the second reflow. Among the external electrode terminals, those mounted on the motherboard 30 are not used before the gas detection apparatus 10 is mounted on the motherboard 30. Hence, the production process can be completed in the most reliable state without any deterioration of the terminals. In addition, the wiring that was connected to the second external electrode terminals 72 and remains on the board 2 can be used for electrical testing in the event that a malfunction occurs in the gas detection apparatus 10 after the second reflow. Furthermore, it is required that the second reflow described in the present embodiment have minimal impact on the components fixed by the first reflow. For example, the temperature control in the second reflow is stricter than that in the first reflow, and at this time, the front line remaining on the gas detection apparatus 10 may be used to check the mounting quality after the second reflow. The wiring connected to the second external electrode terminals 72 may be exposed at the end surface of the board 2 from the perspective of ease of access.

Furthermore, the board 2 is formed so that the board area of the board 2 is equal to or greater than a certain area after the second external electrode terminals 72 are removed along the guide. By having a certain area or more, the board 2 can ensure sufficient heat capacity during the second reflow even after the second external electrode terminals 72 are removed along the guide. That is, it is possible to reduce the likelihood that the heat capacity of the board 2 will be insufficient, which would make the temperature rise at a faster rate, causing the mounted components of the light emitter and light detector to remelt and resulting in misalignment of the mounting. Suppressing misalignment during mounting is effective in preventing deterioration of the characteristics of the gas sensor. Furthermore, by setting the board area of the board 2 after the second external electrode terminals 72 are removed to be a certain area or less, it is possible to reduce the likelihood of mounting error, due to the board 2 not being sufficiently heated by the second reflow, and of deformation of the board 2, such as warpage, due to uneven temperature. As an example of an embodiment that can suppress mounting defects and misalignment, the board 2 (first board) after the second external electrode terminals 72 have been removed along the guide for removal preferably has long sides of 35 mm or less, short sides of 20 mm or less, and an area of 121 mm² or more. A board 2 that satisfies these conditions can suppress the phenomenon whereby components fixed to the board 2 shift from their fixed positions due to overheating during the second reflow and can reduce the likelihood of deformation of the board 2, such as warpage, or a mounting error on the first board, i.e., the board 2, as a result of insufficient or uneven heating of the board 2.

### First variation

An example of a component mounting method according to a first variation will be described.

The component mounting method according to the first variation differs from the component mounting method according to the present embodiment in that in step S103 of the component mounting method according to the present embodiment, the windproof filter 51 is attached to the ventilation opening 52 after the first reflow has been performed and before the optical member 5 is fixed onto the board 2, whereas in step S103A of the component mounting method according to the first variation, the windproof filter 51 is attached to the ventilation opening 52 after the optical member 5 is fixed onto the board 2 and before the output of the gas detection apparatus 10 is calibrated. Since the other steps S101 to S102 and S104 to S109 are the same, redundant explanations will be omitted.

In step S103A, the operator prepares the optical member 5 and the windproof filter 51. Next, the operator fixes the optical member 5 onto the board 2 with an adhesive, for example, so that the optical member 5 contacts the wiring 8 in a partial region. Next, the operator attaches the windproof filter 51 to the ventilation opening 52.

According to the component mounting method of the first variation, a decrease in reliability of the gas detection apparatus 10 mounted on the motherboard 30 by the second reflow can be suppressed. Furthermore, by attaching the windproof filter 51 to the ventilation opening 52 after the optical member 5 is fixed to the board 2 and before the output of the gas detection apparatus 10 is calibrated, dust can be prevented from entering the interior of the gas detection apparatus 10 during calibration.

### Second variation

An example of a component mounting method according to a second variation will be described.

The component mounting method according to the second variation differs from the component mounting method according to the present embodiment in that in steps S103 and S104 of the component mounting method according to the present embodiment, the windproof filter 51 is attached to the ventilation opening 52, the optical member 5 is then fixed onto the board 2, and the output of the gas detection apparatus 10 is then calibrated, whereas in steps S103B and S104B of the component mounting method according to the second variation, the windproof filter 51 is attached to the ventilation opening 52 after the output of the gas detection apparatus 10 has been calibrated and before the second reflow is performed. Since the other steps S101 to S102 and S105 to S109 are the same, redundant explanations will be omitted.

In step S103B, the operator prepares the optical member 5 and the windproof filter 51. Next, the operator fixes the optical member 5 onto the board 2 with an adhesive, for example, so that the optical member 5 contacts the wiring 8 in a partial region.

In step S104B, the controller 6 calibrates the output of the gas detection apparatus 10 in accordance with the first detection information output from light detector 4 after the first reflow. Next, the operator attaches the windproof filter 51 to the ventilation opening 52.

According to the component mounting method of the second variation, a decrease in reliability of the gas detection apparatus 10 mounted on the motherboard 30 by the second reflow can be suppressed. Furthermore, by attaching the windproof filter 51 to the ventilation opening 52 after the output of the gas detection apparatus 10 has been calibrated and before the second reflow is performed, the ventilation speed during calibration in the gas detection apparatus 10 can be improved, and the calibration speed can be increased.

While the above embodiments have been described as representative examples, it will be apparent to those skilled in the art that many modifications and substitutions may be made within the spirit and scope of the present disclosure. Therefore, the present disclosure should not be construed as being limited to the above embodiments, and various modifications and changes can be made without departing from the scope of the patent claims. For example, multiple processes illustrated in the flowcharts of the embodiments may be combined into one step, or a single process may be divided. For example, the various processes described above may not only be performed in chronological order as described but may also be performed in parallel or separately depending on the processing capabilities or needs of the apparatuses performing the processes. Other modifications can be made as appropriate without departing from the spirit of the present disclosure.

1. A component mounting method comprising:
a first step of mounting a light emitter, a light detector, and a controller on a first surface of a first board comprising external electrodes having at least a first external electrode terminal group and a second external electrode terminal group;
a second step of fixing, to the first surface, an optical member configured to propagate light from the light emitter to the light detector, the optical member covering the light emitter, the light detector, and the controller and having a shape capable of forming a predetermined space between the optical member and the first surface of the first board;
a third step of calibrating an output of at least one of the light emitter, the light detector, and the controller, in accordance with first detection information based on an output of the light detector; and
a fourth step of mounting a second surface of the first board on one surface of a second board, wherein
in the fourth step,
the first external electrode terminal group is connected to the second board,
the second external electrode terminal group is removed from the first board, and
when observed from a direction perpendicular to the first surface of the first board, centers of gravity of areas respectively occupied by the light emitter and the light detector are at positions different from a center of gravity of an area occupied by the external electrodes.

2. The component mounting method according to claim 1, wherein the optical member has a ventilation opening at a position not overlapping with the light emitter and the light detector in the direction perpendicular to the first board.

3. The component mounting method according to claim 2, further comprising a step of attaching a filter to the ventilation opening of the optical member between the first step and the second step.

4. The component mounting method according to claim 3, wherein the filter attached to the ventilation opening of the optical member is attached on the predetermined space side.

5. The component mounting method according to claim 2, further comprising a step of attaching a filter to the ventilation opening of the optical member between the second step and the third step.

6. The component mounting method according to claim 2, further comprising a step of attaching a filter to the ventilation opening of the optical member between the third step and the fourth step.

7. The component mounting method according to claim 1, wherein the optical member is set to overlap partially or entirely with wiring electrically connected to the light emitter, the light detector, and the controller, in a top view.

8. The component mounting method according to claim 1, wherein the first step and the fourth step include a reflow process.

9. The component mounting method according to claim 1, wherein the optical member has an average light reflectance of 70 % or more in a wavelength range of 2 μm to 20 μm over a range of 50 % or more of an outer surface.

10. The component mounting method according to claim 1, further comprising a fifth step of performing, by the controller, self-calibration in accordance with first detection information based on the output of the light detector after calibration in the third step and second detection information based on the output of the light detector after the fourth step.

11. The component mounting method according to claim 10, further comprising, between the fourth step and the fifth step,
a step of determining whether the second detection information is valid; and
a step of further determining, by the controller, whether the second detection information is recoverable by self-calibration in a case in which it is determined that the second detection information is not valid.

12. The component mounting method according to claim 1, wherein a calibration program used in the third step is downloaded using the second external electrode terminal group.

13. A gas detection apparatus board comprising:
a first board comprising external electrodes having at least a first external electrode terminal group and a second external electrode terminal group; and
a light detector, a light emitter, and a controller mounted on a first surface of the first board, and an optical member fixed to the first surface of the first board so as to cover the light detector, the light emitter, and the controller, wherein
the second external electrode terminal group has a guide for removal from the first board, and
a number of electrodes in the second external electrode terminal group is equal to or greater than a number of electrodes in the first external electrode terminal group.

14. The gas detection apparatus board according to claim 13, wherein the second external electrode terminal group is arranged on a first surface and a second surface of the first board, and the first external electrode terminal group is arranged on the second surface of the first board.

15. The gas detection apparatus board according to claim 13, wherein external dimensions of the first board after the second external electrode terminal group is removed from the first board along the guide for removal are long sides of 35 mm or less, short sides of 20 mm or less, and an area of 121 mm² or more.

16. The gas detection apparatus board according to claim 13, wherein after the second external electrode terminal group is removed from the first board along the guide for removal, at least a portion of wiring connected to the second external electrode terminal group is exposed on a side surface of the first board.

17. The gas detection apparatus board according to claim 13, wherein
the gas detection apparatus board further comprises a storage, and
the controller is permitted to access a first area of the storage in a case of being based on a signal input from the second external electrode terminal group, and the controller is permitted to have limited access to a second area corresponding to a portion of the first area of the storage in a case of being based on a signal input from the first external electrode terminal group.

18. A gas detection apparatus system comprising:
a first board;
a light emitter, a light detector, a controller, and a storage mounted on a first surface of the first board, the storage storing at least calibration information;
an optical member covering the light emitter, the light detector, and the controller, having a shape capable of forming a predetermined space between the optical member and the first surface of the first board, and having a ventilation opening at a position not overlapping with the light emitter and the light detector in a direction perpendicular to the first board;
a plurality of external electrodes arranged on a second surface of the first board,
when observed from a direction perpendicular to the first surface of the first board, centers of gravity of areas respectively occupied by the light emitter and the light detector being at positions different from a center of gravity of an area occupied by the plurality of external electrodes; and
a second board connected to the plurality of external electrodes of the first board, wherein
power is supplied from the second board to the first board through the plurality of external electrodes, and
after power is supplied, self-calibration can be performed in accordance with detection information and the calibration information, the detection information being based on an output of the light detector.

19. The gas detection apparatus system according to claim 18, wherein
the controller is configured to communicate with the light detector,
the controller is configured to execute the self-calibration in response to input, from the light detector, of detection information satisfying a predetermined first condition, and
the controller is configured to output an error flag in response to input, from the light detector, of detection information not satisfying the first condition.

20. The gas detection apparatus system according to claim 18, wherein the plurality of external electrodes is arranged in a region obtained by projecting, onto the second surface along a direction perpendicular to the first surface, a region of the first surface that overlaps with the optical member when viewed from the direction.
